(19) United States
(12) Patent Application Publication
(10) Pub. No.: US 2023/0356324 A1
(43) Pub. Date: Nov. 9, 2023

(54) LASER PROCESSING SYSTEM HAVING OPTICAL DIFFRACTION TOMOGRAPHY FUNCTION

(71) Applicant: Innofocus Photonics Technology Pty Ltd, Shenzhen, Guangdong (CN)

(72) Inventors: Baohua JIA, Victoria (AU); Tao YAO, Victoria (AU)

(21) Appl. No.: 18/042,999

(22) PCT Filed: Jul. 26, 2021
(86) PCT No.: PCT/CN2021/108374

§ 371 Date: Feb. 24, 2023

(30) Foreign Application Priority Data
Aug. 27, 2020 (CN) 202010876885.7

(51) Int. Cl. B23K 26/03; B23K 26/0622; B23K 26/06; G01B 9/027; G01B 9/02001; G01B 9/02

(52) U.S. Cl. CPC B23K 26/032; B23K 26/0624; B23K 26/0626; G01B 9/027; G01B 9/02011; G01B 9/02051; B23K 2103/56

(57) ABSTRACT

The invention provides a laser processing system having the function of optical diffraction tomography, comprising: an integrated imaging optical path and a processing optical path; the imaging optical path is used to perform optical diffraction tomography on the device to be processed; the processing optical path is used for processing the device to be processed. Moreover, the specific optical path structure is introduced. During the processing of the device to be processed, the laser processing system can also perform real-time imaging of the device to be processed without shifting the device to be processed. That is to say, the laser processing and imaging processing of the device to be processed can be realized at the same time in a laser processing system.

This application claims the priority of the Chinese patent application submitted to the China Patent Office on Aug. 27, 2020, with the application number 202010876885.7, and the title of the invention is “Laser processing system having optical diffraction tomography function”, the entire content of which incorporated in this application by reference.

### TECHNICAL FIELD

The invention relates to the technical field of semiconductor processing, more specifically, to a laser processing system having optical diffraction tomography function.

### BACKGROUND TECHNIQUE

Laser processing technology is a processing technology that uses the characteristics of the interaction between laser beams and materials to perform cutting, welding, surface treatment, drilling, and micro-processing of materials (including metals and non-metals).

As an advanced manufacturing technology, laser processing technology has been widely used in important sectors of the national economy, such as automobiles, electronics, electrical appliances, aviation, metallurgy, and machinery manufacturing, and has played an increasingly significant role in improving product quality, labor productivity, automation, pollution-free and reducing material consumption.

However, in the current laser processing field, processing and imaging are realized in two separate optical systems.

### CONTENTS OF THE INVENTION

In view of this, in order to solve the above problems, the present invention provides a laser processing system having optical diffraction tomography function, and the technical scheme is as follows:
a laser processing system with an optical diffraction tomography function, the laser processing system comprises: an integrated imaging optical path and a processing optical path;
the imaging optical path is used for optical diffraction tomography imaging of the device to be processed;
the processing optical path is used for processing the device to be processed.

Optionally, in the above laser processing system, the imaging optical path includes a first laser, a first polarizing beam splitter, a dual-axis scanning galvomirror, a first objective lens, a second objective lens, and a non-polarizing flat beam splitter;
the device to be processed is located between the first objective lens and the second objective lens;
the first laser is used to emit an imaging laser;
the first polarizing beam splitter is used to split the imaging laser light into signal light and reference light;
the dual-axis scanning galvomirror is used to two-dimensionally scan the signal light to form a scanning beam, and the scanning beam is focused on the back focal plane of the first objective lens to irradiate the device to be processed in different directions;
the second objective lens is used to collect transmitted light signals passing through the device to be processed;
the non-polarizing plate beam splitter combines the reference light and the transmitted light signal to form an off-axis hologram at a certain off-axis angle, and an image acquisition device captures the off-axis hologram.

Optionally, in the above laser processing system, the imaging optical path further includes:
a rotating polarizer and a first half-wave plate arranged sequentially between the first laser and the first polarizing beam splitter;
the rotating polarizer is used to adjust the total light intensity of the imaging laser;
the half-wave plate is used to adjust the splitting ratio of the imaging laser.

Optionally, in the above laser processing system, the imaging optical path further includes:
a first optical fiber and a first collimator lens arranged sequentially between the first polarizing beam splitter prism and the dual-axis scanning galvomirror;
the first optical fiber is used to transmit the signal light;
the first collimating lens is used for collimating the signal light.

Optionally, in the above laser processing system, the imaging optical path further includes:
a second collimating lens arranged between the dual-axis scanning galvanometer and the first objective lens;
the second collimating lens is used for collimating the scanning light beam.

Optionally, in the above laser processing system, the imaging optical path further includes:
a third collimating lens arranged between the second objective lens and the non-polarizing plate beam splitter;
the third collimating lens is used for collimating the transmitted light signal.

Optionally, in the above laser processing system, the imaging optical path further includes:
a second optical fiber and a fourth collimating lens arranged sequentially between the first polarizing beam splitter and the non-polarizing flat beam splitter;
the second optical fiber is used to transmit the reference light;
the fourth collimating lens is used for collimating the reference light.

Optionally, the first laser is a single longitudinal mode continuous laser in the above laser processing system.

Optionally, an anti-reflection coating is further provided on the non-polarizing flat beam splitter in the above laser processing system.

Optionally, in the above laser processing system, the processing optical path includes: a second laser, a laser power adjusting device, a beam expander, and a dichroic mirror;
the second laser is used to emit the processing laser;
the laser power adjusting device is used to adjust the power of the processing laser;
the beam expander is used to expand the processing laser beam;
the dichroic mirror is used to reflect the expanded processing laser light to the second objective lens;
the second objective lens is also used to focus the expanded processing laser light on the device to be processed.

Optionally, in the above laser processing system, the laser power adjusting device includes:
the second half-wave plate and the second polarizing beam splitter prism are sequentially arranged on the outgoing light path of the second laser.

Optionally, in the above laser processing system, the beam expander includes:
a fifth collimating lens, a aperture, and a sixth collimating lens are sequentially arranged between the second polarizing beam-splitting prism and the dichroic mirror.

Optionally, in the above laser processing system, the aperture is located on a focal plane of the fifth collimating lens and the sixth collimating lens.

Optionally, the second laser is a femtosecond pulsed laser in the above laser processing system.

Optionally, the dichroic mirror reflects the processing laser light and transmits the transmitted light signal in the above-mentioned laser processing system.

Compared with the prior art, the beneficial effects realized by the present invention are:
a laser processing system having optical diffraction tomography function provided by the present invention includes: an integrated imaging optical path and a processing optical path; the imaging optical path is used for optical diffraction tomography imaging of the device to be processed; the processing optical path is used for processing the device to be processed.

That is to say, in processing the device to be processed, the laser processing system can also perform real-time imaging of the device to be processed without shifting the device to be processed, that is to say, in a laser processing system, the laser processing and imaging processing of the device to be processed are realized at the same time.

### DESCRIPTION OF DRAWINGS

In order to more clearly illustrate the technical solutions in the embodiments of the present invention or the prior art, the following will briefly introduce the drawings that need to be used in the description of the embodiments or the prior art. Obviously, the accompanying drawings in the following description are only embodiments of the present invention, and those skilled in the art can also obtain other drawings according to the provided drawings without creative work.

FIG. 1 is a schematic structural diagram of a laser processing system having optical diffraction tomography function provided by an embodiment of the present invention;

FIG. 2 is a schematic structural diagram of another laser processing system having optical diffraction tomography function provided by an embodiment of the present invention.

### DETAILED EMBODIMENTS

The following will clearly and completely describe the technical solutions in the embodiments of the present invention with reference to the accompanying drawings in the embodiments of the present invention. Obviously, the described embodiments are only some, not all, embodiments of the present invention. Based on the embodiments of the present invention, all other embodiments obtained by persons of ordinary skill in the art without making creative efforts belong to the protection scope of the present invention.

In an embodiment of the present invention, a laser processing system with an optical diffraction tomography imaging function is provided, and the laser processing system includes: an integrated imaging optical path and a processing optical path.

The imaging optical path is used for optical diffraction tomography imaging of the device to be processed.

The processing optical path is used for processing the device to be processed.

In this embodiment, during the processing of the device to be processed, the laser processing system can also perform real-time imaging of the device to be processed without shifting the device to be processed, that is, in a laser processing system, the laser processing and imaging processing of the device to be processed can be realized at the same time.

In order to make the above objects, features, and advantages of the present invention more comprehensible, the present invention will be further described in detail below in conjunction with the accompanying drawings and specific embodiments.

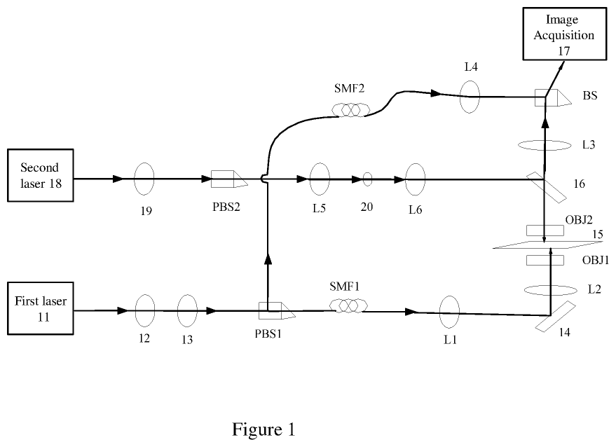

Referring FIG. 1, FIG. 1 is a schematic structural diagram of a laser processing system having optical diffraction tomography function provided by an embodiment of the present invention.

The imaging optical path includes: a first laser 11, a first polarizing beam splitter prism PBS1, a dual-axis scanning galvomirror 14, a first objective lens OBJ1, a second objective lens OBJ2, and a non-polarizing flat beam splitter BS.

The device to be processed 15 is located between the first objective lens OBJ1 and the second objective lens OBJ2.

The first laser 11 is used to emit the imaging laser.

The first polarizing beam splitter prism PBS1 is used to split the imaging laser light into signal light and reference light.

The dual-axis scanning galvomirror 14 is used to perform two-dimensional scanning of the signal light to form a scanning light beam, and the scanning light beam is focused on the back focal plane of the first objective lens OBJ1 to irradiate the device to be processed 15 in different directions.

The second objective lens OBJ2 is used for collecting transmitted light signals passing through the device to be processed 15.

The non-polarizing flat beam splitter BS combines the reference light and the transmitted light signal to form an off-axis hologram at a certain off-axis angle. The off-axis hologram is collected by the image acquisition device 17 to perform data acquisition.

In this embodiment, the device 15 to be processed is placed on a translational stage, which is not shown in the figure, and the position is between the first objective lens OBJ1 and the second objective lens OBJ2.

As shown in FIG. 1, after the first laser 11 emits imaging laser beam, the imaging laser beam is divided into signal light and reference light by the first polarizing beam splitter prism PBS1, the signal light is used for imaging, and the reference light is used for holographic imaging.

Combined with the dual-axis scanning galvomirror 14 to scan the signal light two-dimensionally, the scanning light beam is focused on the back focal plane of the first objective lens OBJ1 to realize the irradiation of the device to be processed 15 in different directions.

The second objective lens OBJ2 collects the transmitted light signal passing through the device to be processed 15, and sends the transmitted light signal to the non-polarizing plate beam splitter BS.

At the non-polarizing flat beam splitter BS, the transmitted light signal and the reference light are combined to form an off-axis hologram at a certain off-axis angle, and the off-axis hologram is acquired by the image acquisition device 17.

The three-dimensional refractive index distribution of the device to be processed can be obtained by performing a series of operations such as deholography, Rytov approximation, spectrum stitching, and filtering on the scattered light field holograms captured at different angles.

Further, based on the above-mentioned embodiments of the present invention, as shown in FIG. 1, the imaging optical path further includes:
the rotating polarizer 12 and the first half-wave plate 13 are sequentially arranged between the first laser 11 and the first polarizing beam splitter prism PB S 1.

The rotating polarizer 12 is used to adjust the total light intensity of the imaging laser.

The half-wave plate 13 is used to adjust the splitting ratio of the imaging laser.

In this embodiment, the rotating polarizer 12 and the first half-wave plate 13 are sequentially arranged on the laser output optical path of the first laser 11, and are mainly used to adjust the light intensity of the imaging laser.

Further, based on the above-mentioned embodiments of the present invention, as shown in FIG. 1, the imaging optical path further includes:
the first optical fiber SMF1 and the first collimating lens L1 are sequentially arranged between the first polarizing beam splitter prism PBS1 and the dual-axis scanning galvanometer 14.

The first optical fiber SMF1 is used to transmit the signal light.

The first collimating lens L1 is used for collimating the signal light.

In this embodiment, including but not limited to using the first optical fiber SMF1 to transmit the signal light, and combining the first collimating lens L1 to collimate the signal light, the beam quality can also be improved.

Further, based on the above-mentioned embodiments of the present invention, as shown in FIG. 1, the imaging optical path further includes:
a second collimating lens L2 arranged between the dual-axis scanning galvanometer 14 and the first objective lens OBJ1.

The second collimating lens L2 is used for collimating the scanning light beam.

In this embodiment, combining with the second collimator lens L2 to collimate the scanning light beam, the propagation quality of the light beam in the imaging optical path can also be improved.

Further, based on the above-mentioned embodiments of the present invention, as shown in FIG. 1, the imaging optical path further includes:
a third collimating lens L3 arranged between the second objective lens OBJ2 and the non-polarizing plate beam splitter BS.

The third collimating lens L3 is used for collimating the transmitted light signal.

In this embodiment, combining with the third collimator lens L3 to collimate the transmitted light signal, the beam propagation quality in the imaging optical path can also be improved.

Further, based on the above-mentioned embodiments of the present invention, as shown in FIG. 1, the imaging optical path further includes:
the second optical fiber SMF2 and the fourth collimating lens L4 are sequentially arranged between the first polarizing beam splitter prism PB Si and the non-polarization plate beam splitter BS.

The second optical fiber SMF2 is used to transmit the reference light.

The fourth collimating lens L4 is used for collimating the reference light.

In this embodiment, including but not limited to using the second optical fiber SMF2 to transmit the reference light, and combining the fourth collimator lens L4 to collimate the signal light, the beam quality can also be improved.

It should be noted that, in order to ensure that the signal light and the reference light can reach the image acquisition device 17 at the same time, it is necessary to set a delay sub-optical path structure on the optical path of the reference light. In the embodiment of the present invention, no specific delay sub-optical structure is given.

Optionally, the first laser 11 includes but is not limited to a single longitudinal mode continuous laser.

Optionally, an anti-reflection coating is also provided on the non-polarizing flat beam splitter BS to improve the light transmittance of the reference light and the signal light.

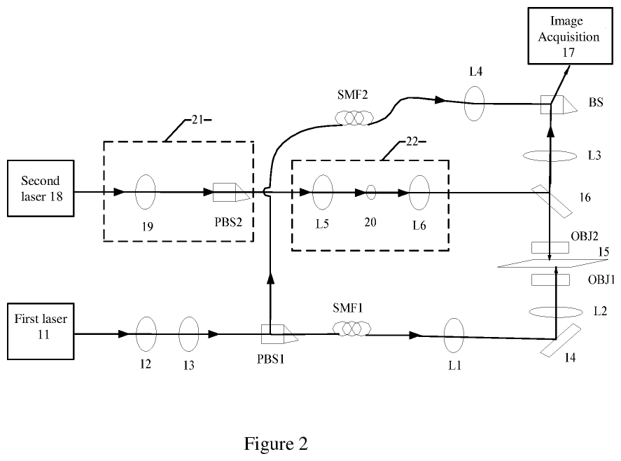

Further, based on the above-mentioned embodiments of the present invention, refer to FIG. 2, which is a schematic structural diagram of another laser processing system having optical diffraction tomography function provided by an embodiment of the present invention.

The processing optical path includes: a second laser 18, a laser power adjusting device 21, a beam expander 22, and a dichroic mirror 16.

The second laser 18 is used to emit processing laser light.

The laser power adjusting device 21 is used to adjust the power of the processing laser.

The beam expander 22 is used to expand the processing laser.

The dichroic mirror 16 is used to reflect the expanded processing laser light to the second objective lens OBJ2.

The second objective lens OBJ2 is also used to focus the expanded processing laser light on the device to be processed 15.

In this embodiment, after the second laser 18 emits the processing laser, the power of the processing laser is adjusted by the laser power adjusting device 21, that is, the processing power is adjusted.

Subsequently, beam expansion processing is performed on the processing laser light in combination with the beam expander 22.

Afterwards, the beam expanded processing laser light is reflected by the dichroic mirror 16 and focused by the second objective lens OBJ2 on the device to be processed 15 to realize the processing of the device to be processed 15.

During the experiment, by changing the processing power of the processing laser, combined with optical diffraction tomography technology, the change in the refractive index of the device to be processed at different processing powers can be obtained, and the processing laser with the appropriate power can be selected to complete the laser processing of the device to be processed.

Further, based on the above-mentioned embodiments of the present invention, as shown in FIG. 2, the laser power adjusting device 21 includes:

The second half-wave plate 19 and the second polarizing beam splitter prism PBS2 are sequentially arranged on the outgoing light path of the second laser 18.

In this embodiment, the combination of the second half-wave plate 19 and the second polarizing beam splitter prism PBS2 is used to realize the adjustment of the processing laser power.

Further, based on the above-mentioned embodiments of the present invention, as shown in FIG. 2, the beam expander 22 includes:

The fifth collimating lens L5, the aperture 20, and the sixth collimating lens L6 are sequentially arranged between the second polarization beam splitting prism PBS2 and the dichroic mirror 16.

Wherein, the aperture 20 is located on the focal planes of the fifth collimating lens L5, and the sixth collimating lens L6.

Specifically, the aperture 20 is used for spatially filtering the processing laser beam, so that the intensity distribution of the light spot is more uniform.

The sixth collimating lens L6 is used in conjunction with the fifth collimating lens L5 to collimate the beam focused, pass through the aperture 20, and convert the focused beam into a collimated beam.

Optionally, the second laser 18 includes but is not limited to a femtosecond pulsed laser.

Further, based on the above-mentioned embodiments of the present invention, the dichroic mirror 16 reflects the processing laser light, and transmits the transmitted light signal.

That is, the dichroic mirror 16 selects a passband, transmits the imaging laser (e.g., 561 nm imaging laser), and reflects the processing laser (e.g., 1030 nm processing laser).

It can be known from the above description that a laser processing system having optical diffraction tomography function provided by the present invention includes: an integrated imaging optical path and a processing optical path; the imaging optical path is used for optical diffraction tomography of the device to be processed; the processing optical path is used for processing the device to be processed. Moreover, the specific optical path structure is introduced. During processing the device to be processed, the laser processing system can also perform real-time imaging of the device to be processed without the need to shift the device to be processed. That is to say, in a laser processing system, laser processing and imaging processing of the device to be processed can be realized at the same time.

A laser processing system having optical diffraction tomography function provided by the present invention has been introduced in detail. In this invention, specific examples have been used to illustrate the principle and implementation of the present invention. The description of the above embodiments is only to help understand the method of the present invention and its core idea; at the same time, for those of ordinary skill in the art, according to the idea of the present invention, there will be changes in the specific implementation and scope of application. In summary, the content of this specification should not be construed as a limitation of the invention.

It should be noted that each embodiment in this specification is described in a progressive manner, and each embodiment focuses on the differences from other embodiments. The same and similar parts in each embodiment can be referred to as each other. As for the system disclosed in the embodiment, since it corresponds to the method disclosed in the embodiment, the description is relatively simple, and for the related information, please refer to the description of the method part.

It should also be noted that in this invention, relational terms such as first and second, etc. are only used to distinguish one entity or operation from another entity or operation, and do not necessarily require or imply that these entities or operations have such actual relationship or order between them. Furthermore, the term “comprises”, “includes” or any other variation thereof is intended to cover a non-exclusive inclusion such that elements inherent in a process, method, object, or apparatus comprising a set of elements are included, or are also included as such, method, object or apparatus inherent in the elements. Without further limitations, an element defined by the phrase “comprising a . . . ” does not exclude the presence of additional identical elements in the process, method, object or apparatus comprising said element.

The above description of the disclosed embodiments is provided to enable any person skilled in the art to make or use the invention. Various modifications to these embodiments will be readily apparent to those skilled in the art, and the general principles defined herein may be implemented in other embodiments without departing from the spirit or scope of the invention. Therefore, the present invention will not be limited to the embodiments shown herein, but is to be accorded the widest scope consistent with the principles and novel features disclosed herein.

1. A laser processing system having optical diffraction tomography function, characterized in that the laser processing system includes: an integrated imaging optical path and a processing optical path;
the imaging optical path is used for optical diffraction tomography imaging of the device to be processed;
the processing optical path is used for processing the device to be processed.

2. The laser processing system according to claim 1, wherein the imaging optical path includes: a first laser, a first polarizing beam splitter, a dual-axis scanning galvomirror, a first objective lens, a second objective lens, and a non-polarizing flat plate beam splitter;
the device to be processed is arranged between the first objective lens and the second objective lens;
the first laser is used to emit the imaging laser;
the first polarizing beam splitter is used to split the imaging laser light into signal light and reference light;
the dual-axis scanning galvomirror is used to two-dimensionally scan the signal light to form a scanning beam, and the scanning beam is focused on the back focal plane of the first objective lens to irradiate the device to be processed in different directions;
the second objective lens is used to collect transmitted light signals passing through the device to be processed;
the non-polarizing plate beam splitter is used to combine the reference light and the transmitted light signal to form an off-axis hologram at a certain off-axis angle, and the off-axis hologram is acquired by an image acquisition device.

3. The laser processing system according to claim 2, wherein the imaging optical path further comprises:
a rotating polarizer and a first half-wave plate are arranged sequentially between the first laser and the first polarizing beam splitter;
the rotating polarizer is used to adjust the total light intensity of the imaging laser;
the half-wave plate is used to adjust the splitting ratio of the imaging laser.

4. The laser processing system according to claim 2, wherein the imaging optical path further comprises:
a first optical fiber and a first collimating lens are arranged sequentially between the first polarizing beam splitter prism and the dual-axis scanning galvomirror;
the first optical fiber is used to transmit the signal light;
the first collimating lens is used for collimating the signal light.

5. The laser processing system according to claim 2, wherein the imaging optical path further comprises:
a second collimating lens is arranged between the dual-axis scanning galvanometer and the first objective lens;
the second collimating lens is used for collimating the scanning light beam.

6. The laser processing system according to claim 2, wherein the imaging optical path further comprises:
a third collimating lens is arranged between the second objective lens and the non-polarizing plate beam splitter;
the third collimating lens is used for collimating the transmitted light signal.

7. The laser processing system according to claim 2, wherein the imaging optical path further comprises:
a second optical fiber and a fourth collimating lens are arranged sequentially between the first polarizing beam splitter and the non-polarizing flat beam splitter;
the second optical fiber is used to transmit the reference light;
the fourth collimating lens is used for collimating the reference light.

8. The laser processing system according to claim 2, wherein the first laser is a single longitudinal mode continuous laser.

9. The laser processing system according to claim 2, wherein an anti-reflection coating is also provided on the non-polarizing flat beam splitter.

10. The laser processing system according to claim 2, wherein the processing optical path comprises: a second laser, a laser power adjusting device, a beam expander, and a dichroic mirror;
the second laser is used to emit the processing laser;
the laser power adjusting device is used to adjust the power of the processing laser;
the beam expander is used to expand the processing laser beam;
the dichroic mirror is used to reflect the expanded processing laser light to the second objective lens;
the second objective lens is also used to focus the expanded processing laser light on the device to be processed.

11. The laser processing system according to claim 10, wherein the laser power adjusting device comprises:
a second half-wave plate and a second polarizing beam splitter prism are arranged sequentially on the outgoing light path of the second laser.

12. The laser processing system according to claim 11, wherein the beam expander comprises:
a fifth collimating lens, an aperture, and a sixth collimating lens are arranged sequentially between the second polarizing beam splitter prism and the dichroic mirror.

13. The laser processing system according to claim 12, wherein the aperture is arranged on a focal plane of the fifth collimating lens and the sixth collimating lens.

14. The laser processing system according to claim 10, wherein the second laser is a femtosecond pulsed laser.

15. The laser processing system according to claim 10, wherein the dichroic mirror performs reflection on the processing laser light, and performs high-transmission filtering on the transmitted light signal.
